(19) United States
(12) Patent Application Publication
(10) Pub. No.: US 2004/0055941 A1
(43) Pub. Date: Mar. 25, 2004

(54) Pressure saturation and pressure release of liquids for introduction into a flotation cell

(75) Inventors: Heinz-Gunter Weissenberg, Leverkusen (DE); Stefan Neumann, Koln (DE)

Correspondence Address: WILLIAM GERSTENZANG, NORRIS, MCLAUGHLIN & MARCUS, P.A., 220 EAST 42ND STREET, 30TH FLOOR, NEW YORK, NY, 10017, US

(73) Assignee: Bayer Aktiengesellschaft, Leverkusen (DE)

(21) Appl. No.: 10/602,282

(22) Filed: Jun. 24, 2003

(30) Foreign Application Priority Data
Jun. 25, 2002 (DE) 10228261.7

(51) Int. Cl. C02F 1/24

(52) U.S. Cl. 210/221.2

(57) ABSTRACT

Apparatus for pressure saturation of a liquid with a gas comprising

a gas-containing pressure saturation vessel (1),

one or more nozzles (8) for injecting liquid into the pressure saturation vessel (1) at the top of the pressure saturation vessel (1)

tubes (4) which are open at the top and closed at the bottom and are disposed beneath the nozzle or nozzles (8) in the pressure saturation vessel (1), one or more nozzles (8) being assigned to each-dissolver tube (4), and

liquid outlet (16) beneath the dissolver tubes (4) at the bottom of the pressure saturation vessel (1).

The invention relates to an apparatus for pressure saturation of a liquid with a gas and to such an apparatus in combination with an apparatus for pressure release for introducing the depressurized liquid into a flotation cell.

Flotation plants are used for removing solids from aqueous suspensions. For this, gas bubbles are introduced into the suspension, which bubbles adhere to the solids so that they float to the liquid surface. The solid particles may then be removed from the surface of the liquid by skimmers. A known method for generating fine gas bubbles is saturation of a water stream with air under pressures of 3-10 bar. This pressure-saturated water is then added via valves to the water to be purified. During this process a spontaneous pressure drop occurs across the valve from the saturation pressure to the ambient pressure plus the applied hydrostatic pressure in the flotation apparatus, as a result of which the gas solubility is abruptly decreased. The excess gas is then separated out as a formation of fine gas bubbles.

The currently available systems for pressure saturation and pressure release have the following disadvantages

susceptibility to foam formation

low space-time yield of saturation

high equipment requirements and thus high fabrication costs.

It is an object of the invention to provide an apparatus for pressure saturation and pressure release which does not have the disadvantages of the systems of the prior art.

The inventive object is achieved by an apparatus for pressure saturation comprising

a pressure saturation vessel

one or more nozzles for injecting liquid into the pressure saturation vessel at the top of the pressure saturation vessel

tubes (dissolver tubes) open at the top and closed at the bottom which are disposed beneath the nozzle or nozzles in the pressure saturation vessel, one or more nozzles being assigned to each dissolver tube

liquid outlet beneath the dissolver tubes at the bottom of the pressure saturation vessel.

The liquid which is to be saturated with gas, preferably air, is introduced at the top of the pressure saturation vessel via one or more nozzles, preferably conventional smooth jet nozzles. These can be screwed into the lid of the pressure saturation vessel. The pressure drop at the nozzles should be less than 1 bar under operating conditions, preferably less than 0.5 bar.

The nozzle diameters preferably have gap widths at their narrowest flow cross sections greater than 4 mm, which can preclude blockage due to fine particles. In addition, the nozzles can be protected by upstream backwashable screen filters.

The stream of the fed liquid, preferably water, can be subdivided in advance into individual feed tubes. The liquid flow through the individual nozzles can be controlled in each case separately for each nozzle by upstream or downstream shutoff elements, for example by a battery of shutoff stop cocks. By this means the rate of liquid fed to the pressure saturation vessel can be set in accordance with requirements.

The liquid is injected at a speed of greater than 3 m/sec, preferably greater than 6 m/sec. The choice of speed of injection depends on the degree of pressure saturation which is to be achieved for the liquid to be saturated. To achieve a saturation of greater than 90% with water, the injection speed should be greater than 8 m/sec, and for a saturation of more than 95%, greater than 10 m/sec.

In the pressure saturation vessel the liquid of each nozzle first passes through the gas cushion in the intermediate space between the nozzles and the dissolver tubes in the form of a free jet and then enters into the dissolver tubes. The distance between each of the dissolver tubes and the associated nozzle is in the range of 100-400 mm, preferably in the range of 150-250 mm. In the dissolver tubes the liquid is vortexed and exits a short time later from the dissolver tube again at the top. As a result of the liquid which is continuously inflowing from each nozzle, the dissolver tubes into which the nozzles discharge are always filled with liquid. As a result of the passage of the free jet of liquid through the gas cushion, gas molecules are entrained in the jet of liquid and introduced into the interior of the dissolver tube in the form of gas bubbles. As a result of the high shear forces and turbulence in the dissolver tube, intensive contact between gas and liquid occurs, as a result of which the liquid becomes saturated with the gas. Ascending gas bubbles are repeatedly redivided by the liquid flowing into the dissolver tube from the top and are conveyed into the lower regions of the dissolver tube.

To each dissolver tube is preferably assigned one nozzle, but a plurality of nozzles, for example four nozzles, can also be assigned to an individual dissolver tube.

The residence time of the liquid in the dissolver tubes is firstly dependent on the speed of injection and secondly on the ratio of the diameter of the dissolver tubes to the diameter of the assigned nozzles at the liquid outlet of the nozzles.

The following applies here: the greater the ratio of diameter of the dissolver tubes to the diameter of the assigned nozzles, the greater the residence time. With increasing injection speed, the residence time decreases with constant ratio of the diameter of the dissolver tubes to the diameter of the assigned nozzles. Preferably, the ratio of the diameter of the dissolver tube to the diameter of the assigned nozzle in the case of one assigned nozzle is in the range from 3 to 8, preferably 3 to 5, particularly preferably 4. Therefore, when one nozzle of diameter 10 mm at the liquid outlet is used, advantageously a dissolver tube of diameter 40 mm is used.

In the event that four nozzles are assigned to one dissolver tube, the ratio of the diameter of the dissolver tube to the diameter of one of the assigned nozzles is in the range from 6 to 16, preferably 3 to 10, particularly preferably 8, since double the diameter of the dissolver tube represents 4 times the throughput through the nozzles. The ratio must be adapted appropriately in the case of other numbers of nozzles assigned to a dissolver tube.

Under these conditions, the residence time of the liquid in the dissolver tubes is less than 10 sec, preferably less than 5 seconds, particularly preferably less than 2.5 sec.

The liquid flows over from the dissolver tubes and collects or backs up in the lower region of the vessel, where it can exit through the liquid outlet at the bottom of the vessel, below the dissolver tubes. The liquid outlet at the bottom of the gas saturation vessel is dimensioned such that the outflow velocity of the liquid from the gas saturation vessel is in the range between 50 and 150 m/h, preferably in the range between 70 and 90 m/h.

The liquid backed up in the vessel has the function of a bubble filter. Relatively large bubbles (d>100 μm) cannot pass together into the liquid outlet, since they ascend more rapidly than the liquid moves downwards. The level of liquid in the gas saturation vessel is controlled by controlling the gas feed.

The level of liquid in the vessel can be controlled via the level gauge. Preferably, for this purpose, a vertical pipe is connected outside the gas saturation vessel in communication with the vessel interior. A float in the pipe indicates the level. Preferably the float can be detected magnetically and activates a minimum and maximum circuit. In the minimum case, the feed of gas is stopped automatically. In the maximum case the feed of gas is open. The maximum pressure in the vessel may be set by a governor valve in the gas feed line.

By means of the level gauge in combination with the minimum and maximum circuit, not only is the liquid level in the pressure saturation vessel controlled, but also the adequacy of supply of the pressure saturation vessel with gas is ensured. In this manner, as much gas is automatically fed to the liquid as is consumed by the dissolution process.

The solution of the inventive object further comprises an apparatus for pressure saturation and pressure release of liquid for introduction into a flotation cell comprising

a flotation cell,

a pressure saturation vessel whose liquid feed via liquid lines is connected to the liquid outlet of the flotation cell,

one or more pressure release valves which are disposed in the liquid lines between the liquid outlet of the pressure saturation vessel and the liquid feed line to the flotation cell.

The flotation cell which is known per se comprises a baffle plate, an inner pot and an apparatus for circulating skimming by suction on the external part of the liquid surface. The rate of flotate removal in the flotation cell is controlled by controlling liquid inflow (for example dirty water inflow) and outflow of the clean liquids (for example clean water outflow).

The pressure saturation vessel can be one of the above described inventive apparatuses for pressure saturation.

The flow rate of liquid from each pressure release valve can be controlled by an upstream or downstream shutoff element, for example a ball valve. By this means the flotation cell can be operated at different gas introduction rates.

A central shutoff valve can be disposed between the liquid outlet of the pressure saturation vessel and the pressure release valves.

The pressure release valves can consist of perforated plates into which one or more nozzles are screwed. The perforated plates are fitted into flanges in a similar manner as orifice plates. The nozzles used in the pressure release valves can have the flow profile of a simple commercially conventional Laval nozzle.

Alternatively, the pressure release valves can consist of plates into which hole-type nozzles or slotted nozzles having appropriate flow profiles are milled.

The nozzle diameters in the pressure release valves preferably have gap widths greater than 4 mm at their narrowest flow cross sections, as a result of which blockage due to fine particles can be avoided. In addition, the nozzles can be protected by upstream backwashable screen filters.

Between the pressure release valves and the feed line to the flotation cell is preferably situated a liquid line piece in which the depressurized liquid covers a path length in the range from 10 to 100 cm, preferably 10 to 30 cm, before it is added to the feed to the flotation cell. This is advantageous for complete expulsion of the excess gas from the liquid and to achieve a fine-bubbled bubble spectrum having bubble diameters between 30 and 70 μm.

It is advantageous in the inventive apparatus for pressure saturation that foam formation is largely prevented. Floating foam bubbles are destroyed by the liquid jets from the nozzles which intersect the gas space.

Saturation is performed in the inventive apparatus for pressure saturation with a particularly high space-time yield, because with short residence times in the dissolver tubes (less than 10 seconds), a saturation greater than 90% can be achieved.

The inventive apparatuses for pressure saturation and pressure release are made up from very simple components and can thus be fabricated very inexpensively.

It is also advantageous with the inventive apparatuses for pressure saturation and pressure release that by turning on and shutting off individual nozzle elements, the liquid throughput and thus the gas introduction can be controlled in a flexible manner.

### BRIEF DESCRIPTION OF THE DRAWINGS

FIG. 1 illustrates the structure of a: combined pressure saturation/pressure release system having a flotation cell

FIG. 2a) illustrates a pressure release valve made of a perforated plate having conventional nozzles

FIG. 2b) illustrates a pressure release valve having flow profiles milled into a perforated plate and having attached conventional nozzles

FIG. 3 illustrates apparatus for pressure saturation

FIG. 4 illustrates a smooth jet nozzle

FIG. 5 illustrates an expansion nozzle for pressure release valve

FIG. 6 is a graph showing degree of saturation as a function of the exit velocity for nozzles in a pressure saturation vessel having a varying outlet orifice.

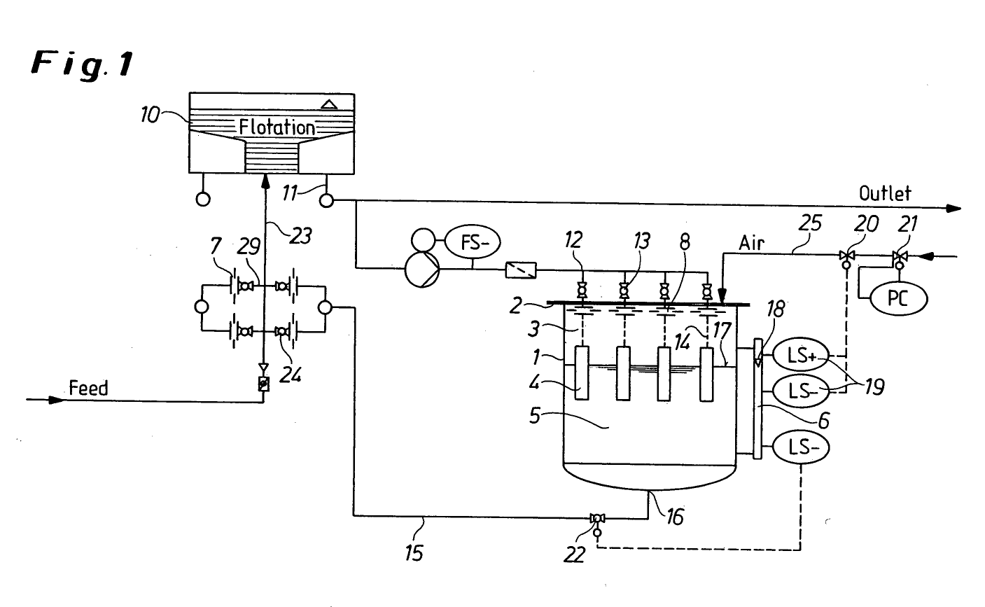

FIG. 1 shows the structure of a combined pressure saturation/pressure release system having a flotation cell 10. For saturation, clear water from the outflow 11 of the flotation cell 10 is passed into a pressure saturation vessel 1. The introduction is performed in a flow-controlled manner at the top of the pressure saturation vessel 1 via one or more conventional smooth jet nozzles 8 which are screwed into the vessel lid 2. The stream of the water fed is subdivided in advance between individual feed tubes 12 which can be individually turned on and shut off by a battery of shutoff valves 13.

In the pressure saturation vessel 1 the liquid, in the form of a free jet 14 first passes through a gas cushion 3 and then enters into a dissolver tube 4, is vortexed there and exits a short time later again at the top. The water flows over from the dissolver tubes 4 and collects or backs up in the lower region 5 of the vessel 1. The liquid exits through the liquid outlet 1,6 at the bottom of the vessel 1.

The level 17 of the water in the vessel 1 is controlled via a level gauge. Preferably, for this purpose, a vertical pipe 6 is connected outside the vessel 1 in communication with the vessel interior. A magnetically detectable float 18 in the,pipe indicates the position of the level 17 and activates a minimum and maximum circuit 19 which is connected to a gas valve 20. In the minimum case, the feed of gas is stopped automatically. In the maximum case, the feed of gas is open. The maximum pressure in the vessel may be set by a governor valve 21 in the gas feed line.

The water flows downstream of the pressure vessel 1 via a central shutoff valve 22 via one or more pressure release valves 7 via subsequent liquid line pieces 29 into the feed line 23 of the flotation cell 10. Individual pressure release valves 7 can be turned on or shut off by the downstream ball valves 24.

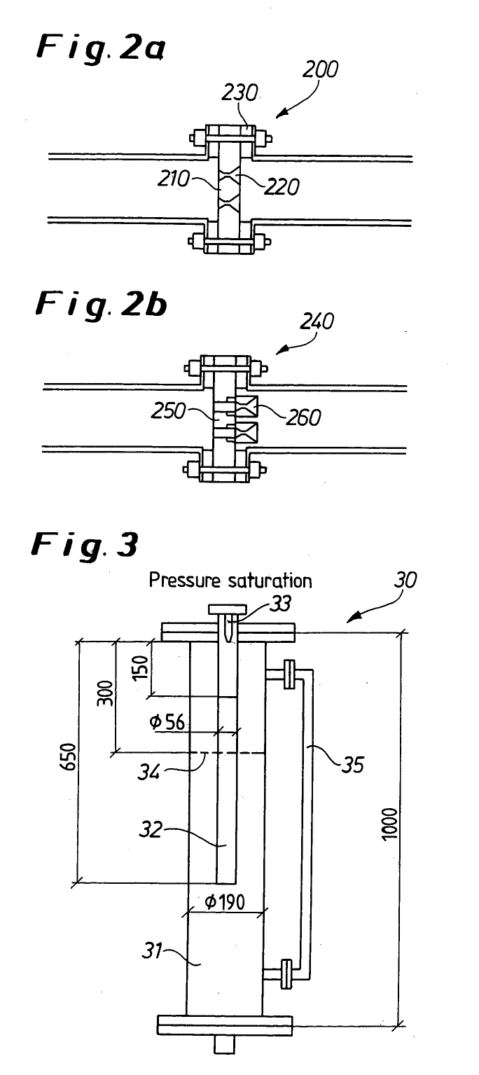

FIG. 2a shows a pressure release valve 200 consisting of a plate 210 into which hole-type or slotted nozzles 220 having corresponding flow profiles are milled. The perforated plate 210 is fitted into the flange 230 in a similar manner to an orifice plate.

FIG. 2b shows a pressure release valve 240 consisting of a perforated plate 250 into which one or more conventional nozzles 260 are screwed.

### EXAMPLE 1

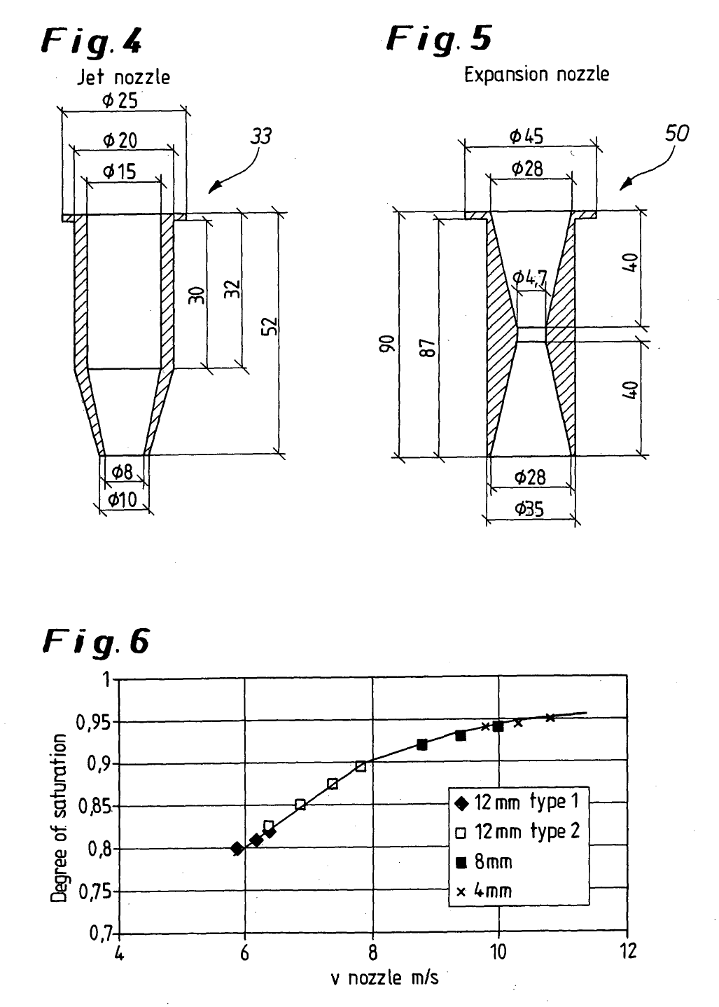

In an experiment, the pressure saturator 30 used was a vessel 31, fabricated from transparent plastic corresponding to FIG. 3. This was a 1000 mm long vertically standing 190 mm internal diameter tubular reactor. In the reactor, a dissolver tube 32, which was 500 mm long and closed at the bottom, was suspended concentrically attached to four steel rods, the distance between the upper edge of the dissolver tube and the lid of the pressure saturator being 150 mm. The distance of 150 mm must then be covered by the liquid entering into the vessel 31 as a free jet until it enters the interior of the dissolver tube 32. The free jet was generated in this case via a smooth jet nozzle 33 having the profile shown in FIG. 4. The flow cross section at the outlet of the nozzle 33 was circular and 8 mm in diameter. The level 34 in the vessel 31 was controlled to 150 mm below the upper edge of the dissolver tube 32.

At the top of the pressure saturator 30, a compressed air feed was attached, in which case the pressure from the service line was decreased to 3 bar by means of a conventional governor valve. In addition, between the governor valve and reactor there was further connected a solenoid valve which opened when the maximum level was achieved and closed at the minimum level. The pressure in the vessel, as a result, was virtually constant at 3 bar.

The water flowed from the vessel 31 via the expansion nozzle 50 shown in FIG. 5 into a degassing vessel. The flow rate of the gas flowing from the degassing vessel was determined via a gas meter.

The expansion nozzle 50 had, at the narrowest point, a circular flow cross section of 4.7 mm in diameter. At the widest point the diameter was 28 mm.

The experimental arrangement was operated with a liquid throughput of 1.5 m³/h. The degree of saturation of the water achieved in this case was 95%. The pressure drop over the smooth jet nozzle was 0.4 to 0.5 bar.

The liquid passing through expansion nozzle 50 was free of bubbles of undissolved gas.

By means of the transparent outer tube of the vessel 31, it could clearly be seen that the downwards-flowing liquid in the vessel was clear in the bottom region and thus bubble-free. Thus the gas introduced into the pressure-release vessel could only have been gas which was previously present in dissolved form exclusively and then had been released again by expansion.

To calculate the saturation, the maximum achievable solubility of air in water in thermodynamic equilibrium at the given temperature and pressure was used as a basis. The saturation is the solubility achieved in the experiment as a per cent of the maximum achievable solubility.

It must be noted in this case that the water entering into the saturator was already saturated with air at atmospheric pressure.

### EXAMPLE 2

The experiment was carried out in a similar mariner to Example 1, except that the flow was not passed into a closed degassing vessel, but into a round transparent flotation cell 10 holding approximately 1 m³ of liquid. In this case, the water depressurized via the expansion nozzle 7 was, in a similar manner to that shown in FIG. 1, added via a horizontal liquid line piece 29 into the vertically standing feed tube 23.

To evaluate the bubble spectrum achieved, the spatial formation of the bubble carpet forming in the flotation cell 10 below the liquid surface, the degree of whiteness of the carpet, and the turbulence of the surface due to the rapid rise of relatively large bubbles were used.

The appearance corresponded under the abovementioned experimental conditions in all aspects to the criteria which are shown by experience to be necessary for a good flotation result. The typically expressed bubble pattern implied a bubble size distribution of 30 to 80 μm in diameter.

It was noteworthy that to achieve a good bubble spectrum an advantageous distance of 200 mm had to exist between the final end of the expansion nozzle 7 and the center of the feed tube 23.

### EXAMPLE 3

A set-up similar to that in Example 1 was employed, except that, in the pressure saturator, nozzles having differing exit orifices and different feed rates were installed.

As a result, different exit velocities of the free jet at the nozzle head were achived. It was found (FIG. 6) that the exit velocity at the nozzle head influences the degree of saturation achieved in the reactor.

The exit velocity was varied in the range from 6 to 11 m per second. The degree of.-saturation achieved was increased in this case from 0.8 to 0.95 (FIG. 6). The degree of saturation was, as described in Example 1, determined by the gas flow rate measured during degassing.

### EXAMPLE 4

An experiment corresponding to Example 3 was repeated, 100 ppm of ethanol being added to the service water used for the experiment, which addition suppresses the coalescence of air bubbles in water. The resultant very fine air bubbles have overall a greater surface area than under coalescence conditions.

It was found that at flow velocities at the nozzle head of 9 to 10 m/s, a saturation of 0.97 to 0.98 was achieved.

### EXAMPLE 5

In a similar manner to Example 4, 100 ppm Mersolat®, an alkane sulfonate surfactant, available from Bayer AG, was added as roamer to the service water used for the experiment. The development of a foam layer in the gas saturation vessel was very largely suppressed, despite the presence of the Mersolat. Those skilled in the art would have expected that pressure saturators which operate by the injector principle used here would overfoam under these conditions.

### EXAMPLE 6

In a similar manner to Example 2, depressurization experiments were carried out in a transparent flotation cell 10, in which the tube length of the liquid pipe piece 29 between expansion valve 7 and the feed tube of the flotation cell 23 was varied. An optimum bubble pattern was first achieved here at a distance of 200 mm between the outlet of the expansion valve 7 and the center of the feed tube 23.

We claim

1. Apparatus for pressure saturation of a liquid with a gas comprising
a gas-containing pressure saturation vessel (1),
one or more nozzles (8) disposed to inject liquid into the pressure saturation vessel (1) at the top of the pressure saturation vessel (1)
one or more tubes (4) open at the top and closed at the bottom disposed beneath said one or more nozzles (8) in the pressure saturation vessel (1), one or more of said nozzles (8) being aligned to discharge into each dissolver tube (4),
a liquid outlet (16) at the bottom of the pressure saturation vessel beneath the dissolver tubes (4).

2. Apparatus according to claim 1, wherein said liquid is water.

3. Apparatus according to claim 1 wherin said gas is air.

4. Apparatus according to claim 1, wherein said nozzles (8) are smooth jet nozzles.

5. Apparatus according to claim 1, wherein the the nozzles (8) are configured to produce a pressure drop under operating conditions of less than 1 bar

6. Apparatus according to claim 5, wherein said pressure drop is less than 0.5 bar.

7. Apparatus according to claim 1, wherein the nozzles (8) are screwed into a lid (2) at the top of the pressure saturation vessel (1).

8. Apparatus according to claim 1, wherein the nozzles (8) have gap widths greater than 4 mm at their narrowest flow cross section.

9. Apparatus according to claim 1, further comprising shut off elements (13) adapted to control the liquid flow rate through the individual nozzles (8) separately.

10. Apparatus according to claim 1, wherein said nozzles are adapted to produce a liquid jet having a velocity of more than 3 m/sec.

11. Apparatus according to claim 10, wherein said velocity is more than 6 m/sec.

12. Apparatus according to claim 1, wherein said apparatus is adapted to inject water into said tubes at a velocity of greater than 8 m/sec, and achieve a saturation of the water of greater than 90%;

13. Apparatus according to claim 12, wherein said saturation is greater than 95%.

14. Apparatus according to claim 1, wherein each of the dissolver tubes (4) has a single nozzle associated with it.

15. Apparatus according to claim 15, wherein the ratio of the diameter of the dissolver tube (4) to the diameter of the associated nozzle (8) is in the range of from 3 to 8.

16. Apparatus of claim 15, wherein said ratio is in the range of from 3 to 5.

17. Apparatus of claim 16, wherein said ratio is 4.

18. Apparatus according to claim 1, wherein each of the dissolver tubes (4) has four nozzles associated with it.

19. Apparatus according to claim 18, wherein the ratio of the diameter of the dissolver tube (4) to the diameter of one of said nozzles (8) is in the range of from 6 to 16.

20. Apparatus according to claim 19, wherein said ratio is in the range of from 6 to 10.

21. Apparatus according to claim 20, wherein said ratio is 8.

22. Apparatus according to claim 1, wherin the distance between each of the dissolver tubes (4) and the at least one nozzle (8) associated with it is in the range of 100-400 mm.

23. Apparatus according to claim 22, wherein said distance is in the range of 150 to 250 mm.

24. Apparatus according to claim 1, adapted to provide a residence time of the liquid in the dissolver tubes (4) of less than 10 sec.

25. Apparatus according to claim 24, wherein said residence time is less than 5 seconds.

26. Apparatus according to claim 25, wherein said residence time is less than 2.5 seconds.

27. Apparatus according to claim 1, wherin the liquid outlet (16) at the bottom of the gas saturation vessel (1) is dimensioned to enable an outflow velocity of the liquid from the gas saturation vessel (1) of from 50 and 150 m/h.

28. Apparatus according to claim 27, wherein said velocity is from 70 to 90 m/h

29. Apparatus according to claim 1, wherin a gas is supplied to the top of said gas saturation vessel through a gas supply line (25) and the amount of gas supplied is adjustable by a control valve 20 to control the level (17) of the liquid in the gas saturation vessel.

30. Apparatus according to claim 1, further comprising a level gauge.

31. Apparatus according to claim 30, wherein said level gauge is a vertical pipe (6) which is outside the gas saturation vessel (1) and is in communication with the vessel interior and within which a float (18) is located.

32. Apparatus according to claim 31, wherin the float (18) is magnetically detectable.

33. Apparatus according to claim 31, wherein the float (18) activates a minimum-maximum circuit (19) which controls the feed of gas to the pressure saturation vessel (1).

34. Apparatus according to claim 32, wherein the float (18) activates a minimum-maximum circuit (19) which controls the feed of gas to the pressure saturation vessle (1).

35. Apparatus according claim 29, further comprising a pressure governor valve (21) in the gas feed line (20).

36. Apparatus for pressure saturation and pressure release of liquid for introduction into a flotation cell comprising
a flotation cell (10),
a pressure saturation vessel (1) having a liquid feed line connected to the liquid outlet of the flotation cell (10),
one or more pressure release valves (7) disposed in liquid lines (23) between the liquid outlet (16) of the pressure saturation vessel (1) and a liquid feed line (23) to the flotation cell (10).

37. Apparatus according to claim 36, wherein the pressure saturation vessel (1) is a pressure saturation vessel according to claim 1.

38. Apparatus according to claim 37, comprising a central shut-off element (22) in the liquid line (15) between the liquid outlet (16) of the pressure saturation vessel (1) and the pressure release valve (7).

39. Apparatus according to claim 38, wherein the liquid flow rate from each pressure release valve (7) is controllable by an upstream or downstream shut-off element (24).

40. Apparatus according to claim 39, wherein the pressure release valves consist of perforated plates (250) into which one or more nozzles (260) are screwed.

41. Apparatus according to claim 39, wherein the pressure release valves consist of plates (210) into which hole-type or slit nozzles (220) are milled.

42. Apparatus according to claim 36, wherein a liquid line piece (29) of a length in the range of 10 to 100 cm is situated between the pressure release valves (7) and the center of the feed tube (23) to the flotation cell.

43. Apparatus according to claim 42, wherein said length is 10 to 30 cm.

44. Apparatus according to claim 36, wherein the pressure release valves (7) have gap widths greater than 4 mm at their narrowest flow cross section.
